(19) United States
(12) Patent Application Publication
(10) Pub. No.: US 2019/0073994 A1
(43) Pub. Date: Mar. 7, 2019

(54) SELF-CORRECTING COMPUTER BASED NAME ENTITY PRONUNCIATIONS FOR SPEECH RECOGNITION AND SYNTHESIS

(71) Applicant: Microsoft Technology Licensing, LLC, Redmond, WA (US)

(72) Inventors: Sarangarajan PARTHASARATHY, Mountain View, CA (US); Osama Mohamad Ahmed ABUELSOROUR, San Jose, CA (US)

(73) Assignee: Microsoft Technology Licensing, LLC, Redmond, WA (US)

(21) Appl. No.: 15/695,544

(22) Filed: Sep. 5, 2017

(51) Int. Cl. G10L 13/08; G10L 25/48; G10L 15/26; G10L 15/183

(52) U.S. Cl. CPC G10L 13/08; G10L 15/183; G10L 15/26; G10L 25/48

(57) ABSTRACT

This disclosure generally relates to a speech pronunciation generation system. The speech pronunciation generation system may be included with or otherwise interact with a speech recognition system, a speech synthesis system, or a combination thereof. The speech pronunciation generation system receives contextual information associated with a named entity, a determined pronunciation of the named entity and feedback associated with the pronunciation. This information may be used to update a pronunciation score associated with the pronunciation. The speech pronunciation generation system may also provide suggested pronunciations of named entities to the input recognition system.

### BACKGROUND

Name pronunciation is a challenge for current speech recognition and speech synthesis systems. For example, the same name may be pronounced differently depending on the origin of the name, letter interpretation of the owner of the name, language and/or dialect of the person speaking the name and so on. This nature of name pronunciation poses a problem in current speech recognition and speech synthesis systems because the current systems rely on generic models to estimate the pronunciation of a name. For example, a speech recognition system may fail to correctly recognize a name that is spoken correctly by a user with a particular dialect or context. Likewise, the speech recognition system may produce or otherwise output a pronunciation of a name that is incorrect given a particular context.

It is with respect to these and other general considerations that examples have been described. Also, although relatively specific problems have been discussed, it should be understood that the examples should not be limited to solving the specific problems identified in the background.

### SUMMARY

This disclosure generally relates to a speech pronunciation generation system. The speech pronunciation generation system of the present disclosure may be part of or otherwise interface with an input recognition system that accepts speech input and converts it to text. Likewise, the speech pronunciation generation system may be part of or otherwise interface with a speech synthesis system that takes text input and renders it as spoken output. As will be described, when input is received by the speech recognition system and/or the speech synthesis system (hereinafter collectively referred to as an input recognition system), the input recognition system may determine a pronunciation of the input, determine a context for the input and provide this information to the speech pronunciation generation system. The input recognition system may also receive feedback on the determined pronunciation. The feedback may also be provided to the speech pronunciation generation system. The speech pronunciation generation system may then use the pronunciation, the feedback and the context to learn proper pronunciation of the input.

In other cases, the speech pronunciation generation system may also provide a determined pronunciation of a named entity (e.g., a proper name such as, for example, a name of a person, a place, an organization, a street name and so on). For example, the input recognition system may request how to pronounce a named entity that was received as input. In such cases, the speech pronunciation generation system may determine, based on received or determined context, how to pronounce the named entity. The pronunciation will then be provided back to the input recognition system.

Accordingly, described herein is a method for determining a pronunciation of provided input. In some cases, the method includes receiving a named entity input and performing a recognition operation on the named entity input. Contextual information associated with the named entity input is also determined or otherwise received. A determination of the pronunciation of the named entity input is then made based, at least in part, on the contextual information and on the recognition operation. The pronunciation of the named entity input is then provided as output.

Also described is a system that includes a processing unit and a memory for storing instructions that, when executed by the processing unit, performs a method. In some cases, the method includes receiving a request for a pronunciation of a named entity received as input. Contextual information with the input may also be determined. In some cases, the contextual information is used to select a subset of pronunciations of the input from a set of possible pronunciations of the input. One pronunciation of the input from the subset of pronunciations of the input is then selected and returned.

In other examples, a method for training a speech pronunciation generation system is disclosed. The method includes receiving input corresponding to a named entity. In some cases, the input also includes at least one of contextual information corresponding to the named entity, a determined pronunciation of the named entity, and feedback associated with the name entity. One pronunciation of the named entity is then selected from a set of pronunciation variants associated with the named entity. A score associated with the one pronunciation of the named entity is then automatically updated.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a system for training a speech pronunciation generation system according to an example.

FIG. 2 illustrates a system for providing a pronunciation of a named entity in response to a received request according to an example.

FIG. 3 illustrates a method for determining a pronunciation of received input according to an example.

FIG. 4 illustrates a method for updating a speech pronunciation generation system according to an example.

FIG. 5 illustrates a method for providing a pronunciation of a named entity to a requesting device according to an example.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Described herein is a speech pronunciation generation system that may be combined with, associated with, or otherwise configured to interact with an input recognition system. As used herein, an input recognition system may include both speech recognition capabilities and speech synthesis capabilities. For example, the input recognition system may receive speech input and convert it to text and also receive text input and render it as spoken output. As will be explained in detail below, the speech pronunciation generation system may be used to provide or verify a determined pronunciation of a named entity that is received as input to the input recognition system.

Additionally, the speech pronunciation generation system may automatically learn correct pronunciations of named entities based on contextual information. As used herein, the term named entity means a proper name such as, for example, a name of a person, a place, an organization, a street name and so on. However, although a named entity is specifically described, the speech pronunciation generation system may be used to determine a pronunciation of various words, terms, phrases and the like based on received or determined contextual information, feedback and/or pronunciations.

For example, the speech pronunciation generation system may receive contextual information associated with a determined pronunciation of a name. Using the contextual information, the speech pronunciation generation system may be able to learn a correct or preferred pronunciation of a named entity. Likewise, feedback that is provided to the input recognition system may also be provided to the speech pronunciation generation system to reinforce or deemphasize a particular pronunciation with respect to determined or received contextual information.

In some instances, the speech pronunciation generation system described herein learns different pronunciations of names, or other words, as they are spoken, or otherwise provided to the input recognition system, in different scenarios by different individuals having different backgrounds and/or ethnicities. The speech pronunciation generation system uses this information to improve speech recognition for names, as well as to create a proper synthesis of how the names should be spoken back to the individual that interacts with the input recognition system.

In some cases, the input recognition system may receive feedback about a particular pronunciation. For example, if the input recognition system provides a pronunciation to the individual that provided the named entity, the individual may provide feedback about the pronunciation. The feedback provided by the individual may be positive, meaning that input recognition system provided a correct pronunciation. The feedback may also be negative, meaning that the input recognition system did not provide a correct pronunciation. In some instances, the feedback may be verbal input, such as, for example, the individual re-emphasizing the pronunciation of the name, providing a different pronunciation of the name and so on. In other cases, a user interface may be provided to the individual. The user interface may display the determined spelling of the name, one or more accent characters or symbols associated with the name, a phonetic spelling of the name, one or more phonemes or other pronunciation characteristics of the name and so on. The individual may provide input on the user interface that corrects or otherwise alters the provided pronunciation.

Once the feedback has been provided, the feedback may be provided to the speech pronunciation generation system. In some cases, speech pronunciation generation system may immediately apply the feedback to the pronunciation of the name. The name, with the updated pronunciation, may be provided again to the individual for confirmation. In addition, the feedback may also be used to determine additional variations of the pronunciation of the name.

The learning process described above is completely unsupervised as it does not require human intervention. That is, the speech pronunciation generation system learns different pronunciations for named entities based only on signals received from an individual or user that provides input to the input recognition system as well as determined or received context. Additionally, any input provided by an individual is not stored or processed offline. Further any data associated with the person whose name is provided as input (e.g., persons whose names appear in a business directory, a telephone directory, contact list, and so on) is not made accessible to a programmer, developer, or user of the input recognition system. As such, the disclosed speech pronunciation generation system is suitable for compliant systems where audio cannot leave a provided compliance boundary.

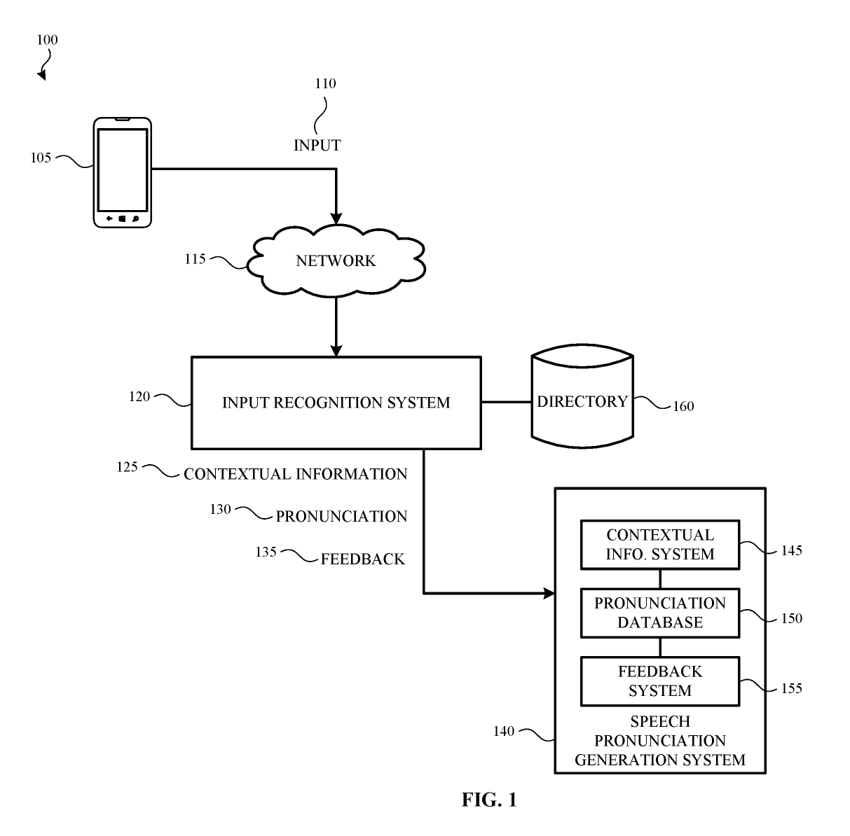

These and other examples will be described in more detail below with respect to FIGS. 1-5.

FIG. 1 illustrates a system 100 for training a speech pronunciation generation system 140 according to an example. As described herein, the speech pronunciation generation system 140 may be trained without human intervention. As shown in FIG. 1, the system 100 may include an input recognition system 120. In some cases, the input recognition system 120 may receive input 110, over a network 115, from a computing device 105. The input 110 may include a named entity.

Once the input 110 is received, the input recognition system 120 may perform a recognition operation on the input 110 to try and determine the correct or intended pronunciation of the named entity contained within the input 110. In order to assist with the determination, the input recognition system 120 may receive or determine contextual information 125 associated with the input 110. In some instances and as will be described below, the contextual information 125 may be provided to the speech pronunciation generation system 140 and used to train the speech pronunciation generation system 140. In other cases, the contextual information 125 may be used to narrow down one pronunciation of the named entity within the input 110 from different variants of the named entity stored in a pronunciation databased 150 within the speech pronunciation generation system 140.

In some instances, the input recognition system 120 may provide a determined pronunciation 130 of the named entity back to the computing device 105. As will be described below, the determined pronunciation 130 may be provided by the speech pronunciation generation system 140. In other cases, the pronunciation 130 of the named entity may be determined by the input recognition system 120.

Once the pronunciation is heard or otherwise received by the individual that provided the input 110, the individual can provide feedback 135 to the system 100. The system 100 uses the feedback 135 to continuously improve its determination on which pronunciation of the input is most appropriate in a given situation.

For example, the input recognition system 120 may provide one or more of the contextual information 125, the pronunciation 130 (when the input recognition system 120 determines a pronunciation of the named entity) and/or any received feedback 135 about the pronunciation to the speech pronunciation generation system 140. The speech pronunciation generation system 140 uses this information to learn new pronunciations for named entities given a particular context. Additionally, the speech pronunciation generation system 140 may refine weights or scores associated with existing pronunciations (e.g., using the feedback 135).

In some cases, the input recognition system 120 may be associated with or otherwise have access to or be integrated with a directory 160 or a contact directory system. For example, the system 100 may be associated with or otherwise integrated with a telephone directory, a business directory, a contact list (e.g., a contact list on a mobile phone or other communication device, an instant messaging application, a collaborative workspace environment or other form of communication software), a personal digital assistant, and so on. Although specific examples are given, the system 100 may be used with any type of system that receives spoken or text input and provides spoken or text output.

In the examples that follow, the system 100 is explained with reference to a directory that lists or otherwise has contact information for various individuals. For example, the system 100 may be associated with an automated business directory or telephone directory that takes a name of an individual as input, determines a pronunciation of the name of the individual, performs a search for contact information associated with the individual, and provides output to requesting individual. In some cases, the output that is provided to the requesting individual includes a pronunciation of the named entity that was originally received. Although a directory 160, and a named entity within the directory 160 are specifically mentioned, the system 100 can be used to provide a pronunciation on various types of received input including names, phrases, places, words and so on.

As briefly described above, the system 100 may include a computing device 105 or other such input device. The computing device 105 may be any device capable of providing input 110 to the system 100. For example, the computing device 105 may be a mobile phone, a POTS or PSTN telephone, a tablet computing device, a laptop computing device, a desktop computer, a wearable electronic device, a gaming machine and so on. In some cases, an individual using or otherwise associated with the computing device 105 uses the computing device 105 to connect to an input recognition system 120.

In the example shown, the computing device 105 can connect to the input recognition system 120 over a network 115. Although a network 115 is shown, the computing device 105 may also connect to the input recognition system 120 over a different communication channel such as a telephone connection, Bluetooth, NFC and the like. Further, although the input recognition system 120 is shown as separate from the computing device 105, in some cases, the input recognition system 120, or portions of the input recognition system, may be integrated within the computing device 105.

As briefly described above, the computing device 105 is used to provide input 110 to the input recognition system 120. The input 110 may be provided to the input recognition system 120 as written input (e.g., text, characters, symbols and so on). In other cases, the input 110 may be provided to the input recognition system 120 as spoken input (e.g., audible words, sounds, phrases and so on). In yet other cases, the input 110 may be provided to the input recognition system 120 as both written input and spoken input.

In some cases, the received input 110 is a named entity (e.g., a first name, a last name, a middle name, a nickname or any combination thereof). For example, the input recognition system 120 may be associated with a business directory and a user of the computing device 105 may be trying to contact a particular individual. As such, a user may access the system 100 using the computing device 105 and provide the individual's name as input 110 to the input recognition system 120. Although names of the individuals are specifically mentioned, the system 100 described herein can be used to provide a pronunciation on various types of received input 110 including names, phrases, places, words and so on. Further, the system 100 may be able to support many different languages.

Once the input 110 has been received by the input recognition system 120, the input recognition system may perform one or more recognition operations on the input 110. The recognition operation may be a speech recognition operation when the input 110 is speech input. When the input 110 is text input, the recognition operation may be a speech synthesis operation that converts the text into speech.

The input recognition system 120 may also be configured to determine contextual information associated with the input 110. In some examples, the contextual information includes a language of the input 110, a location of the computing device 105 (determined, for example, by a GPS locator associated with the computing device 105, an area code or country code used by the computing device 105 when connecting to the system 100, an IP address associated with the computing device 105 and so on) a dialect or accent of the individual that provided the input 110, a language used by the input recognition system 120 (e.g., Spanish, Italian, Mandarin, Arabic, etc.), a language associated with the names in the directory 160, area codes in the directory 160, country codes in the directory 160 and so on.

Once the contextual information is determined, the input recognition system 120 may determine a pronunciation of the named entity included in the input 110. The pronunciation may be provided back to the user of the computing device 105. Once the pronunciation has been received, the user may provide feedback about the pronunciation. For example, if the pronunciation was correct, the user may provide positive feedback. If the pronunciation was incorrect, the user may provide negative feedback.

The contextual information 125, the pronunciation 130 and/or the feedback 135 may subsequently be provided to the speech pronunciation generation system 140. In some cases, this information is provided over a network connection. Although the speech pronunciation generation system 140 is shown as a separate system, the speech pronunciation generation system 140 may be integrated or otherwise incorporated within the input recognition system 120. Additionally, speech pronunciation generation system 140 may be used to determine contextual information 125 associated with the input 110.

In some instances, the speech pronunciation generation system 140 may include a contextual information system 145 that stores received contextual information 125 and/or determines contextual information from the input 110. The speech pronunciation generation system 140 may also include a pronunciation database 150 that stores one or more pronunciation variants of a named entity. In some cases, the pronunciation database 150 may also store one or more scores, weights or probabilities that are associated with the one or more pronunciation variants. Further, each score, weight or probability may be associated with contextual information 125. Thus, one pronunciation of a named entity in the pronunciation database 150 may have a higher weight or score given particular contextual information 125 than another pronunciation variant. The speech pronunciation generation system 150 may also include a feedback system 155. The feedback system 155 may be configured to receive the feedback 135 and adjust the weights, the scores, or the probabilities associated with each pronunciation variant stored in the pronunciation database 150. Although the contextual information system 145, the pronunciation database 150 and the feedback system 155 are shown as separate systems, each of these systems may be combined.

As described above, the pronunciation database 150 may include one or more variants of a pronunciation of a named entity, a word, a phrase and so on. In some cases, the pronunciation database 150 may be populated with name pronunciations from one or more outside or third-party sources. In another example, the pronunciation database 150 may obtain a list of names from the directory 160 and generate one or more pronunciation variants by performing speech recognition or speech synthesis on each entry.

In yet other cases, the pronunciation database 150 may learn various pronunciations of named entities based, at least in part, on the information (e.g., the context 125, the pronunciation 130, and/or the feedback 135) received from the input recognition system 120. As such, the pronunciation database 150 may have multiple entries associated with a named entity. Each entry may be associated with a different pronunciation. In addition, each entry may be associated with a probability or score that indicates which pronunciation is most likely the correct pronunciation based on the contextual information 125 and any feedback 135 on a particular pronunciation 130.

As input 110 and other contextual information is received by the input recognition system 120, the probabilities or scores associated with each entry in the pronunciation database 150 can be automatically updated (e.g., by the feedback system 155). In some examples, the probabilities are updated without human intervention. Without human intervention meaning that a developer, system administrator or other individual does not have access to personal information of each individual listed in the directory 160. However, in some cases, a human may be able to judge a particular pronunciation for a given context and provide additional feedback to the speech pronunciation generation system.

For example, the pronunciation database 150 may include the name Sarah. In one entry, the pronunciation may be “sah-rah” (with the “a's” sounding like the “a” in “bat”). In the other entry, the pronunciation may be “se-rah” (with the “a's” in Sarah sounding like the “a” in “air”). Although two variants are discussed, it is contemplated that a name may have multiple variants in different languages.

Additionally, each entry in the pronunciation database 150 may be associated with a probability or score that may be continuously adjusted, in real time or substantially real time, based on received (or determined) contextual information 125, a determined pronunciation 130 and/or feedback 135. For example, if the contextual information 125 received or otherwise determined by the input recognition system 120 (or the speech pronunciation generation system 140) indicates that the input 110 originated from the west coast of the United States, there may be a high probability that the input 110 of Sarah is pronounced “se-rah.” On the other hand, if the contextual information 125 received or otherwise determined by the input recognition system 120 indicates that the input originated from Scotland, there may be a high probability that the input 110 of Sarah is pronounced “sah-rah.”

The input recognition system may select a pronunciation (or request a proper pronunciation from the speech pronunciation generation system 140 such as will be described below) and provide that pronunciation back to the individual. In some cases, the output is provided as audible output and the individual can hear the input pronunciation determination. In other examples, the output is provided in a user interface. In yet other examples, the pronunciation may include both audible output and visual output (e.g., in a user interface). When used, the user interface may have information about the original input 110 including, but not limited to, a determined spelling of the input 110, one or more phonetic symbols associated with the pronunciation, a phonetic spelling of the pronunciation and so on.

Once the pronunciation has been received by the computing device 105, the individual that originally provided the input 110 may subsequently provide feedback 135. The feedback 135 may be positive feedback that indicates that the pronunciation 130 was correct. Alternatively, the feedback 135 may indicate that the pronunciation 130 was incorrect.

In some cases, the feedback 135 may be verbal or spoken. For example, when pronunciation 130 is provided to the individual, the individual may respond with a confirmation that the pronunciation 130 is correct. Alternatively, the individual may respond by repronouncing the original input 110 thereby indicating that the input pronunciation determination was incorrect (thereby signaling negative feedback 135).

In another example the feedback 135 may be text input. For example, when the pronunciation 130 is provided on a user interface, the individual may change one or more phonetic symbols of the pronunciation 130 and/or a phonetic spelling of the pronunciation 130. In yet another example, the feedback 135 may include both verbal input and text input.

Once the feedback 135 has been provided by the individual, the feedback 135 may subsequently be provided to the speech pronunciation generation system 140. As described above, the feedback 135 may be provided to the speech pronunciation generation system 140 along with the pronunciation 130 and the contextual information 125. This information may then be used to automatically and in real time or substantially real time, adjust the probabilities or scores associated with a particular pronunciation in the pronunciation database 150.

For example, if the feedback 135 was positive, the feedback 135 along with the contextual information 125 and/or the pronunciation 130 may be used to increase the probability or score that the pronunciation 130 of the named entity in the input 110 was correct given the associated contextual information 125. Likewise, if the feedback 135 was negative, this information, along with the contextual information 125 may be used to decrease a probability or score that a determined pronunciation of the named entity within the input 110 was correct. In this way, the speech pronunciation generation system 120 may continuously learn how to better pronounce names, places, phrases and the like based on an originally provided pronunciation 130, contextual information 125 and/or feedback 135.

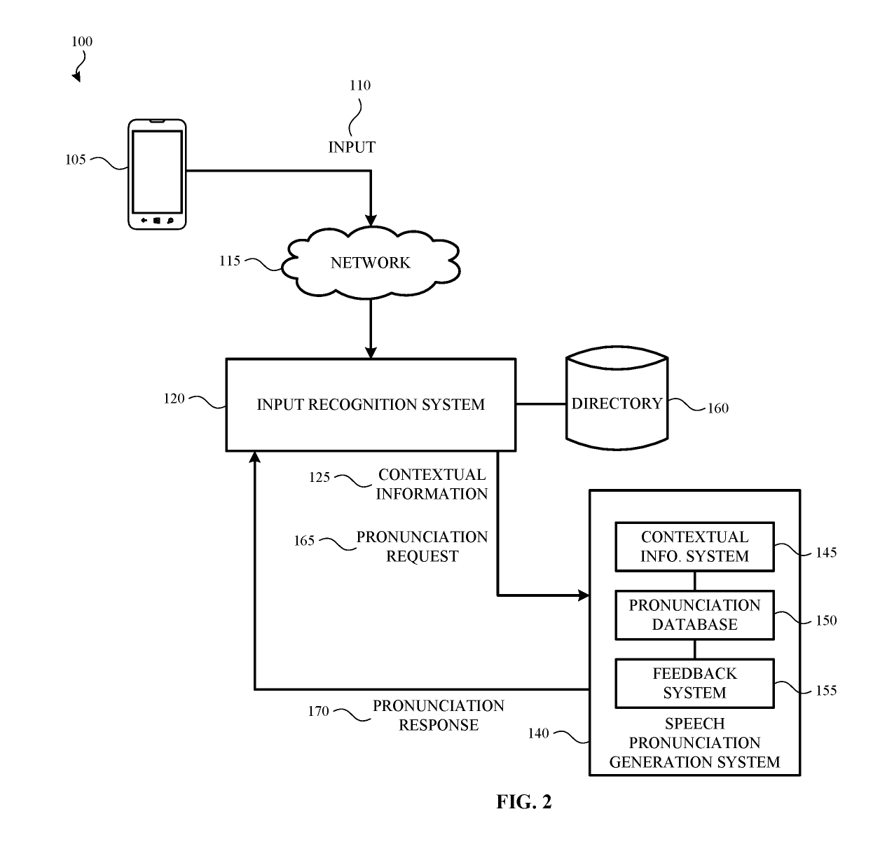

FIG. 2 illustrates the system 100 of FIG. 1 in which a pronunciation of a named entity is provided to the input recognition system 120 in response to a pronunciation request 165. As described above, an input recognition system 120 may receive input 110 that includes a named entity. The input recognition system 120 may perform a recognition operation on the named entity within the input. For example, the input recognition system 120 may convert speech input to text or text input to speech or perform some other operation such that the named entity is in a format that is expected by the speech pronunciation generation system 140.

The input recognition system 120 may also determine contextual information associated with the input 110. For example, the input recognition system 120 may determine a language of a user of the computing device 105, a language utilized by the input recognition system, a country and/or ethnicity of the individual that provided the input 110 based on a caller ID, a network IP address, an area or country code and the like, an intended destination of the input 110 (e.g., in cases in which the input 110 is a telephone call, the country to which the telephone call is to be directed), a detected accent of the individual that provided the input 110 and so on.

Once the contextual information 125 of the input 110 has been determined, the contextual information, along with a pronunciation request 165 for the named entity contained within the input 110, is provided to the speech pronunciation generation system 140. Using the contextual information 125, the speech pronunciation generation system 140 determines which pronunciation of the named entity in the pronunciation database 150 should be returned to the input recognition system. For example, the speech pronunciation generation system 140 may analyze the contextual information 125 and determine that a particular pronunciation of the named entity has the highest probability of being the correct pronunciation. As such, this particular pronunciation is provided to the input recognition system 120 as a pronunciation response 170. The pronunciation response 170 may then be provided to the computing device 105 such as described above.

In some instances, once the pronunciation response 170 has been provided to the computing device, the individual that provided the input 110 may provide feedback such as described above. The feedback may be used to increase a probability or score associated with the pronunciation response 170 or decrease the probability or score associated with the pronunciation response 170.

Although FIG. 2 illustrates the input recognition system 120 determining contextual information 125, this determination may also be made by the speech pronunciation generation system 140.

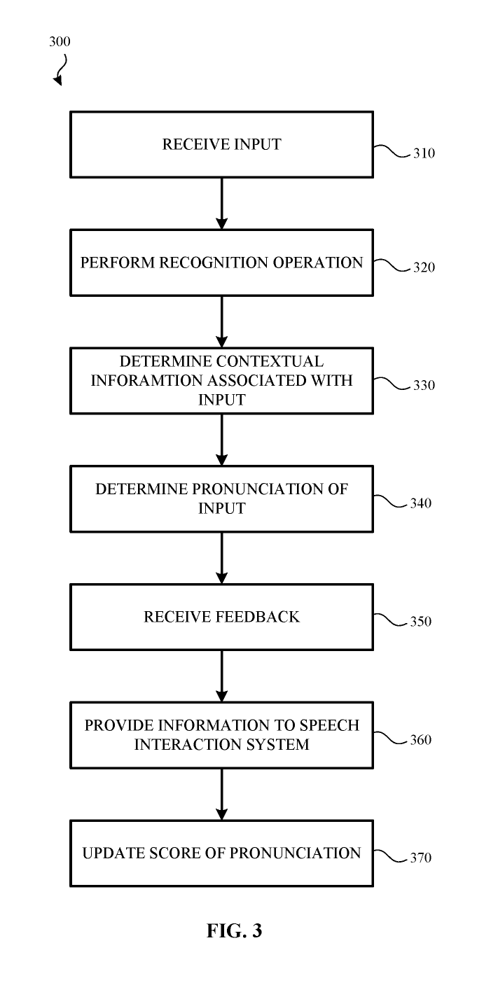

FIG. 3 illustrates a method 300 for determining a pronunciation of received input according to an example. In some cases, the method 300 may be used by the system 100 shown and described with respect to FIG. 1 and FIG. 2.

Method 300 begins at operation 310 in which input is received by an input recognition system. In some cases, the input recognition system may be similar to the input recognition system 120 described with reference to FIG. 1. The input may be provided over a network connection, telephone connection, cellular connection, Bluetooth connection and so on. In other cases, the input recognition system may be integrated with a computing device on which the input is received.

In some instances, the input includes a named entity such as, for example, the name of an individual, the name of a company, the name of a place and so on. Although a named entity is specifically mentioned, the input may only include words, phrases, sentences and so on. Regardless, the speech pronunciation generation system of the present disclosure may be used to provide and/or learn the pronunciation of the input in the same manner as described above. The input may be text input or verbal input. Additionally, the input may be in any language that is recognizable by the input recognition system.

Once the input is received, flow proceeds to operation 320 and a recognition operation is performed on the input. In cases in which the input is speech input, the recognition operation is a speech recognition operation. In cases in which the input is text input, the recognition operation may be a speech synthesis operation. Regardless of the type of operation performed, operation 320 analyzes the received input to generate an initial determination as to the pronunciation of the input. In some cases, the received input may be broken down into various phonemes that represent or are otherwise associated with the input.

Flow then proceeds to operation 330 and contextual information associated with the input is received or determined. The contextual information may include information about the individual that provided the input. Examples include, but are not limited to, a location of the individual, a language spoken by the individual, an accent of the individual, a dialect of the individual, and so on. In some cases, the location of the individual may be determined by a phone number, area code, country code or IP address of a computing device that was used to provide the input to the input recognition system.

Although the contextual information determination is shown after the recognition operation, these two operations may be reversed. Additionally or alternatively, each of these operations may occur simultaneously or substantially simultaneously.

Once the contextual information has been received and the recognition operation has been performed, flow proceeds to operation 340 and a pronunciation of the received input is determined. In some cases, the input recognition system may request one or more pronunciations of the input from a speech pronunciation generation system such as described with respect to FIG. 1. In other cases, the pronunciation may be determined by the input recognition system. In yet other cases, the input recognition system may be associated with a directory and have an associated pronunciation for each named entity in the directory.

Once the pronunciation is generated, the pronunciation may be provided to the individual that provided input. At which time, feedback may be received 350. The feedback may be positive feedback or negative feedback. For example, if the pronunciation of the input in operation 340 was correct, the feedback may be positive. However, if the pronunciation was incorrect, the feedback may be negative.

Once this information is received, the pronunciation, the contextual information and/or the feedback may be provided 360 to the speech pronunciation generation system. The speech pronunciation generation system may use this information to update 370 a probability, a weight or a score associated with the pronunciation that was determined in operation 340. That is, if the feedback about the pronunciation was positive, the speech pronunciation generation system may update (e.g., increase) a score that is associated with the pronunciation with respect to the determined context. Likewise, if the feedback about the pronunciation was negative, the speech pronunciation generation system may decrease a score that is associated with the pronunciation with respect to the determined context.

For example, the speech pronunciation generation system may include a pronunciation database that includes pronunciation variants for various named entities. Each pronunciation variant may be associated with a score and contextual information. Thus, if the contextual information indicates that the input originated from a certain country or from a certain language, a pronunciation variant that is associated with that country or language may be given a higher probability than another pronunciation that is not associated with that country or language.

For example, an individual may provide the input of David to the input recognition system using a computing device. The input (either written, spoken, or a combination thereof) of David is analyzed and the input recognition system may initially determine that the input of David should be pronounced “day-vid.”

However, the contextual information determined by the input recognition system may indicate that the input originated from Spain based on the country code (e.g., +34) that is associated with the computing device that provided the input.

In some cases, the input recognition system may then determine that the pronunciation of the input “David” should be pronounced “daa-veed.” That pronunciation may then be provided to the individual that originally provided the input. In some instances, the output is audible output. In other cases, the output is provided on a user interface. The user interface and/or the audible output may include a determined spelling of the input, phonetic symbols associated with the output, a phonetic spelling of the output and so on.

Once the pronunciation of “daa-veed” has been provided to the individual, the individual may provide feedback. For example, the individual may provide positive feedback by stating that they want to speak to “daa-veed.” Alternatively, the individual may provide negative feedback may stating that they wanted to speak to “day-vid.”

The feedback, along with the contextual information and the determined pronunciation, may be provided to the speech pronunciation generation system. The speech pronunciation generation system uses this information to update a score of the particular pronunciation (“day-veed”) in association with the determined contextual information (e.g., that the input originated from Spain). As such, the speech pronunciation generation system may be better able to determine that when similar contextual information is received, along with a given named entity, the pronunciation of “day-veed” has a higher probability of being the correct pronunciation.

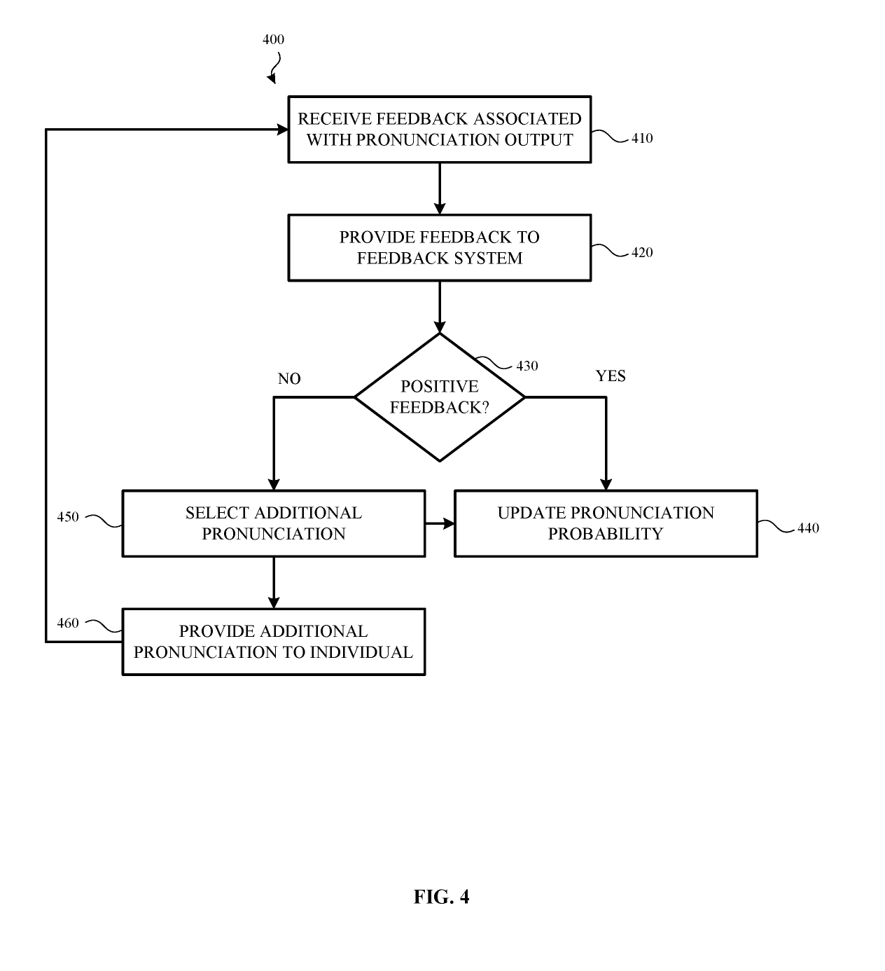

FIG. 4 illustrates a method 400 for updating a speech pronunciation generation system according to an example. Method 400 begins at operation 410 in which feedback is received about the determined pronunciation of a named entity. For example, the pronunciation may have been provided in operation 340 of method 300. In some cases, the feedback may be text input, spoken input or a combination thereof. For example, the individual that provides the feedback may correct a spelling of the name, repronounce the name, indicate that the pronunciation was incorrect and the like.

Once the individual has given the feedback, flow proceeds to operation 420 and the feedback is provided to a feedback system, such as, for example, feedback system 155 (FIG. 1). The feedback system 155 determines 430 the type of feedback received. For example, the feedback system may determine whether the feedback is negative or positive.

If it is determined that the feedback is positive, flow proceeds to operation 440 and the feedback is used to update a probability or score associated with the pronunciation determination (e.g., the pronunciation output that was provided in operation 340 of method 300). For example, if the feedback is positive, the probability of the pronunciation determination, with respect to the determined contextual information, is increased.

However, if it was determined in operation 430 that the feedback was negative, flow proceeds to operation 450 and an additional pronunciation may be selected. For example, if a pronunciation database has different pronunciation variants for a particular input, the pronunciation with the next highest probability is selected based on the determined context. Flow may also proceed to operation 440 in which the probability of the particular pronunciation may be decreased given the determined context.

Flow may also proceed to operation 460 and the additional pronunciation is provided as output to the individual. Flow may then proceed back to operation 410 and the process may repeat.

Continuing with the example of David from the above, the system may determine that “daa-veed” has the highest probability of being correct based on the determined or received contextual information. Accordingly, the pronunciation of “daa-veed” is provided as output.

If the individual that receives the output provides positive feedback, indicating that this pronunciation is correct, the feedback is used to train the system that the pronunciation of “daa-veed” is most likely the correct pronunciation when the call originates from Spain, the caller speaks Spanish, the system provides output in Spanish and so on. As such, a probability associated with the pronunciation of “daa-veed” may also be updated.

In some cases, the system may pair a particular pronunciation with certain contextual information. Thus, in this case, the pronunciation of “daa-veed” may be associated with contextual information of Spain, Spanish and so on.

However, if additional contextual information is received about the same pronunciation, this contextual information may also be associated with the particular pronunciation. For example, if it is determined that David is more likely to be pronounced as “daa-veed” in Sweden, the contextual information of Sweden, Swedish and so on may be associated with this particular pronunciation. In other instances, a new entry of the pronunciation of “daa-veed” and the newly received contextual information may be added to the pronunciation database.

Referring back to the example above, if the individual that receives the output provides negative feedback, (e.g., by responding to the output by stating “No, I said daa-vit′.”) indicating that the provided pronunciation is incorrect, the negative feedback is used to select a different pronunciation. Additionally, the negative feedback may be used train the system that the pronunciation of “daa-veed” was not the correct pronunciation based on the received or determined context. Accordingly, a probability or score associated with “daa-veed” may be decreased.

Based on the feedback and the contextual information, the system may determine that “daa-vit” is the intended pronunciation and this particular pronunciation is provided back to the individual. The individual may provide positive feedback which may update a probability of this particular pronunciation with the determined or received contextual information. If the probability of the pronunciation that was provided first (e.g., the “daa-veed” pronunciation) was not already updated, it may also be updated at this time such as described above.

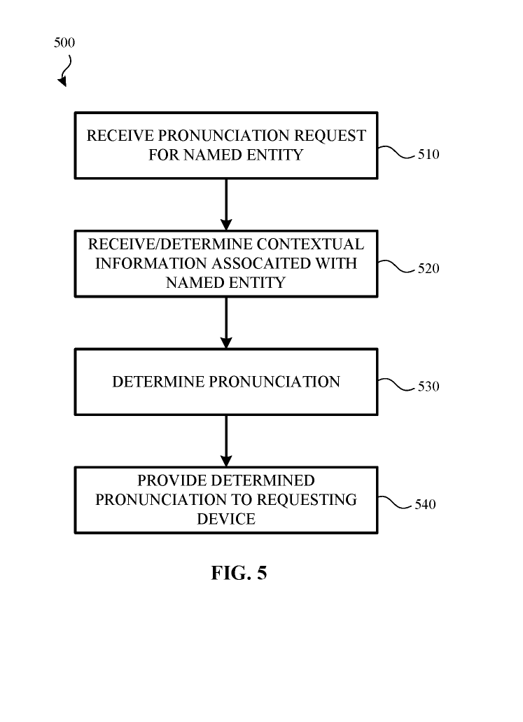

FIG. 5 illustrates a method 500 for providing a pronunciation of a named entity to a requesting device according to an example. In some instances, the method 500 may be utilized by various systems associated with an input recognition system. More specifically, the method 500 may be utilized by a speech pronunciation generation system such as described above.

Method 500 begins at operation 510 in which a pronunciation request for a named entity is received. In some cases, the pronunciation request may be provided to the speech pronunciation generation system from an input recognition system that received input from an individual, a computing device or the like. As described above, the input may include a named entity with which the pronunciation request is associated. For example, when the input recognition system receives input, the input may be analyzed to determine whether a named entity is provided in the input. The named entity, along with a pronunciation request, may be provided to the speech pronunciation generation system.

Flow then proceeds to operation 520 and contextual information associated with the named entity is received. In some cases, the contextual information may be received from the input recognition system. In other cases, the speech pronunciation generation system may be configured to determine the contextual information.

Once the contextual information is received and/or determined, flow proceeds to operation 530 and a pronunciation of the named entity is determined. In making this determination, the contextual information may be compared against contextual information associated with various pronunciation variants of the named entity. The pronunciation variant with the highest probability score (while still being associated with the contextual information) may be determined as the most correct pronunciation.

Flow may then proceed to operation 540 and the determined pronunciation may be provided back to the requesting device. In some cases, once the determined pronunciation has been provided back to the requesting device, the requesting device may provide feedback to the speech pronunciation generation system such as described above. As such, the speech pronunciation generation system may continuously learn how to pronounce various named entities.

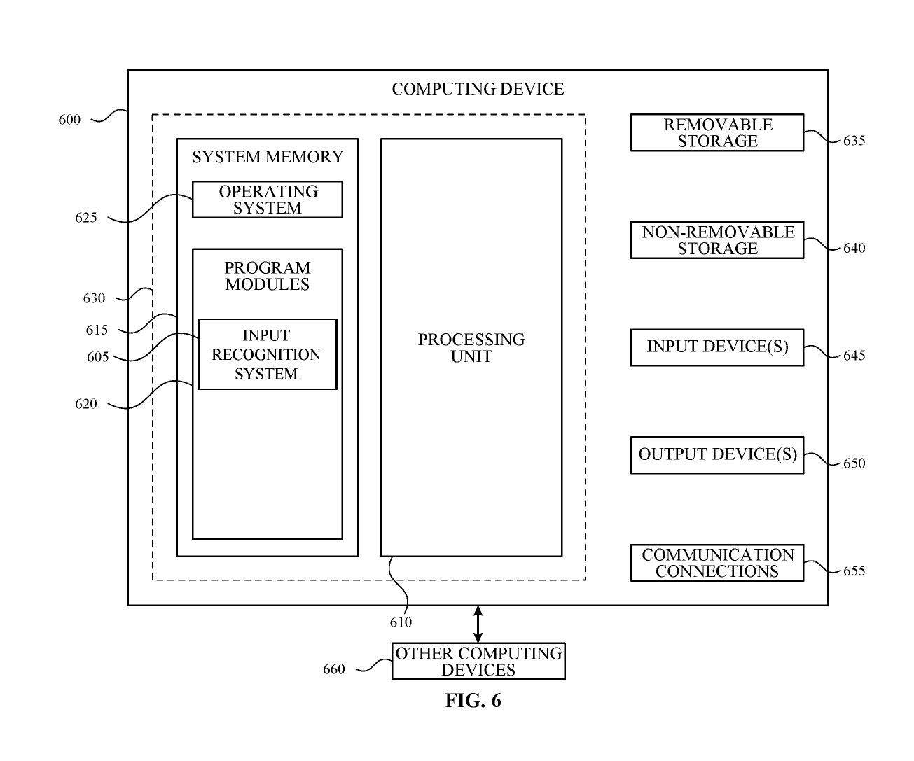

FIGS. 6-9 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, as described herein.

FIG. 6 is a block diagram illustrating physical components (e.g., hardware) of a computing device 600 with which aspects of the disclosure may be practiced. The computing device 600 may be similar to the computing device 105 the input recognition system 120, and/or the speech pronunciation generation system 140 described above with respect to FIG. 1. The components of the computing device 600 described below may have computer executable instructions for automatically identifying or recognizing received input such as described above.

In a basic configuration, the computing device 600 may include at least one processing unit 610 and a system memory 615. Depending on the configuration and type of computing device, the system memory 615 may comprise, but is not limited to, volatile storage (e.g., random access memory), non-volatile storage (e.g., read-only memory), flash memory, or any combination of such memories. The system memory 615 may include an operating system 625 and one or more program modules 620 or components suitable for identifying various objects contained within captured images such as described herein.

The operating system 625, for example, may be suitable for controlling the operation of the computing device 600. Furthermore, examples of the disclosure may be practiced in conjunction with a graphics library, other operating systems, or any other application program and is not limited to any particular application or system. This basic configuration is illustrated in FIG. 6 by those components within a dashed line 630.

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 635 and a non-removable storage device 640.

As stated above, a number of program modules and data files may be stored in the system memory 615. While executing on the processing unit 610, the program modules 620 (e.g., an input recognition system 605 that may include one or more of the various systems described above with respect to FIG. 1) may perform processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 600 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general purpose computer or in any other circuits or systems.

The computing device 600 may also have one or more input device(s) 645 such as a keyboard, a trackpad, a mouse, a pen, a sound or voice input device, a touch, force and/or swipe input device, etc. The output device(s) 650 such as a display, speakers, a printer, etc. may also be included. The aforementioned devices are examples and others may be used. The computing device 600 may include one or more communication connections 655 allowing communications with other computing devices 660. Examples of suitable communication connections 655 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 615, the removable storage device 635, and the non-removable storage device 640 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

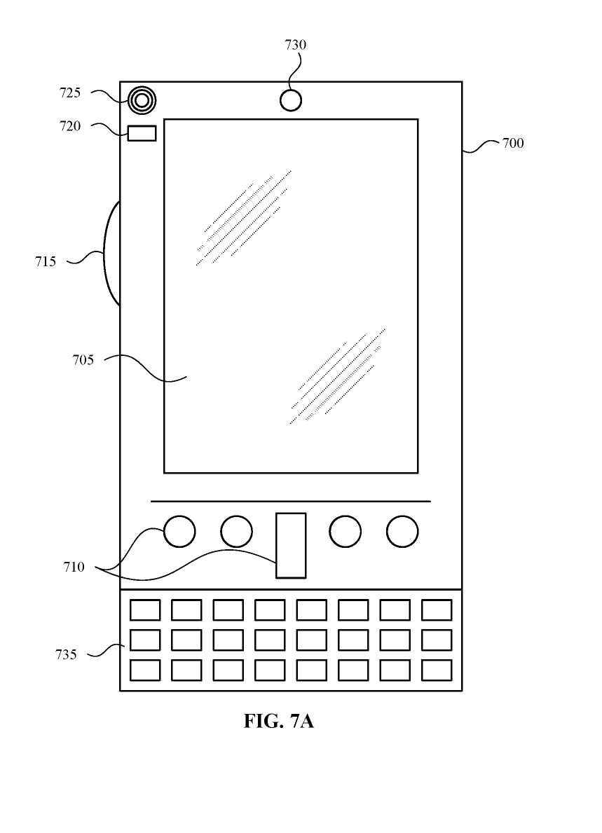

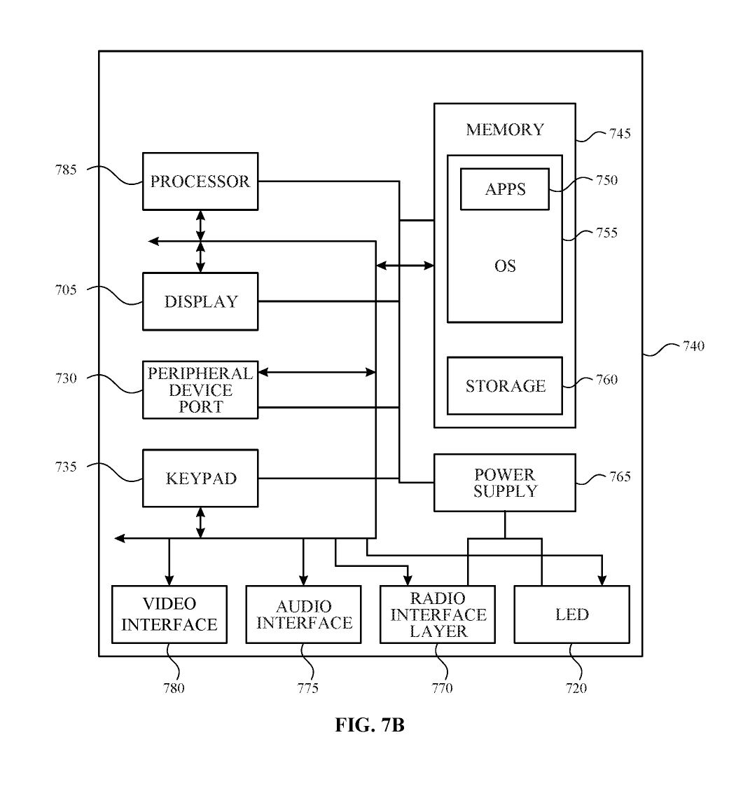

FIGS. 7A and 7B illustrate a mobile computing device 700, for example, a mobile telephone, a smart phone, wearable computer (such as a smart watch), a tablet computer, a laptop computer, and the like, with which examples of the disclosure may be practiced. With reference to FIG. 7A, one aspect of a mobile computing device 700 for implementing the aspects is illustrated.

In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a display that accepts touch and/or force input).

If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some examples. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display.

In various examples, the output elements include the display 705 for showing a graphical user interface (GUI) (such as the one described above that provides visual representation of a determined pronunciation and may receive feedback or other such input, a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device 700. That is, the mobile computing device 700 can incorporate a system (e.g., an architecture) 740 to implement some aspects. In one embodiment, the system 740 is implemented as a “smart phone” capable of running one or more applications (e.g., browser, e-mail, calendaring, contact managers, messaging clients, games, media clients/players, content selection and sharing applications and so on). In some aspects, the system 740 is integrated as an computing device, such as an integrated personal digital assistant (PDA) and wireless phone.

One or more application programs 750 may be loaded into the memory 745 and run on or in association with the operating system 755. Examples of the application programs include phone dialer programs, e-mail programs, personal information management (PIM) programs, word processing programs, spreadsheet programs, Internet browser programs, messaging programs, and so forth.

The system 740 also includes a non-volatile storage area 760 within the memory 745. The non-volatile storage area 760 may be used to store persistent information that should not be lost if the system 740 is powered down.

The application programs 750 may use and store information in the non-volatile storage area 760, such as email or other messages used by an email application, and the like. A synchronization application (not shown) also resides on the system 740 and is programmed to interact with a corresponding synchronization application resident on a host computer to keep the information stored in the non-volatile storage area 760 synchronized with corresponding information stored at the host computer.

The system 740 has a power supply 765, which may be implemented as one or more batteries. The power supply 765 may further include an external power source, such as an AC adapter or a powered docking cradle that supplements or recharges the batteries.

The system 740 may also include a radio interface layer 770 that performs the function of transmitting and receiving radio frequency communications. The radio interface layer 770 facilitates wireless connectivity between the system 740 and the “outside world,” via a communications carrier or service provider. Transmissions to and from the radio interface layer 770 are conducted under control of the operating system 755. In other words, communications received by the radio interface layer 770 may be disseminated to the application programs 750 via the operating system 755, and vice versa.

The visual indicator 720 may be used to provide visual notifications, and/or an audio interface 775 may be used for producing audible notifications via an audio transducer (e.g., audio transducer 725 illustrated in FIG. 7A). In the illustrated embodiment, the visual indicator 720 is a light emitting diode (LED) and the audio transducer 725 may be a speaker. These devices may be directly coupled to the power supply 765 so that when activated, they remain on for a duration dictated by the notification mechanism even though the processor 785 and other components might shut down for conserving battery power. The LED may be programmed to remain on indefinitely until the user takes action to indicate the powered-on status of the device.

The audio interface 775 is used to provide audible signals to and receive audible signals from the user (e.g., voice input such as described above). For example, in addition to being coupled to the audio transducer 725, the audio interface 775 may also be coupled to a microphone to receive audible input, such as to facilitate a telephone conversation. In accordance with examples of the present disclosure, the microphone may also serve as an audio sensor to facilitate control of notifications, as will be described below.

The system 740 may further include a video interface 780 that enables an operation of peripheral device 730 (e.g., on-board camera) to record still images, video stream, and the like.

A mobile computing device 700 implementing the system 740 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 760.

Data/information generated or captured by the mobile computing device 700 and stored via the system 740 may be stored locally on the mobile computing device 700, as described above, or the data may be stored on any number of storage media that may be accessed by the device via the radio interface layer 770 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 770 or via a distributed computing network. Similarly, such data/information may be readily transferred between computing devices for storage and use according to well-known data/information transfer and storage means, including electronic mail and collaborative data/information sharing systems.

As should be appreciated, FIG. 7A and FIG. 7B are described for purposes of illustrating the present methods and systems and is not intended to limit the disclosure to a particular sequence of steps or a particular combination of hardware or software components.

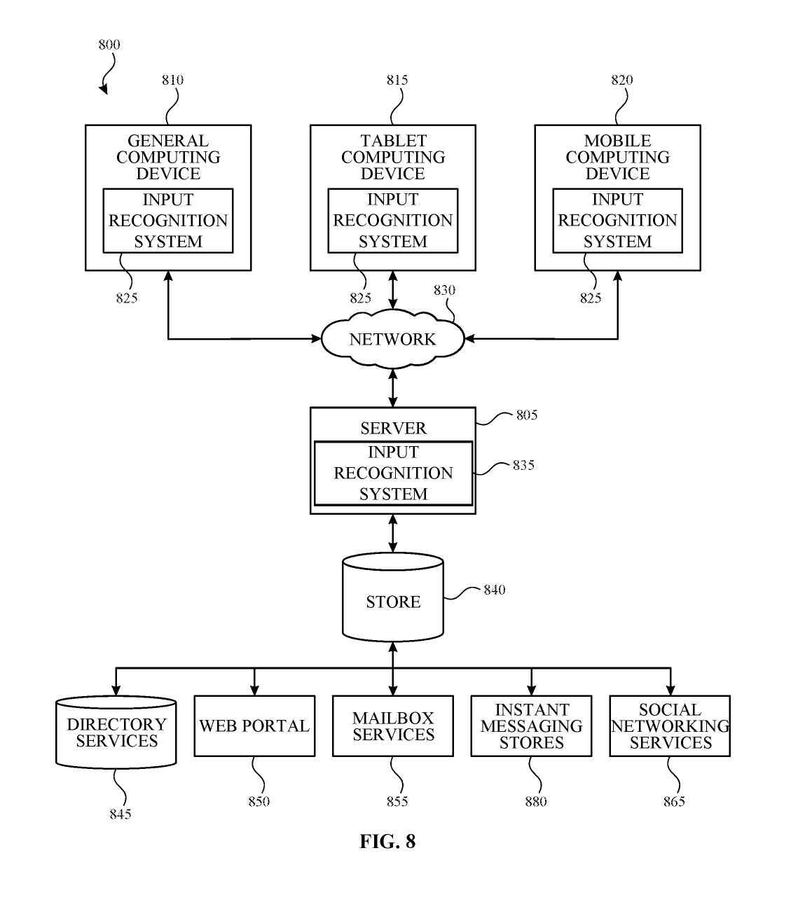

FIG. 8 illustrates one aspect of the architecture of a system 800 for automatically identifying objects within one or more capture images such as described herein. The system 800 may include a general computing device 810 (e.g., personal computer), tablet computing device 815, or mobile computing device 820, as described above. Each of these devices may include, be a part of or otherwise be associated with an input recognition system 825 (or portions thereof) such as described herein.

In some aspects, each of the general computing device 810 (e.g., personal computer), tablet computing device 815, or mobile computing device 820 may receive various other types of information or content that is stored by or transmitted from a directory service 845, a web portal 850, mailbox services 855, instant messaging stores 860, or social networking services 865.

In aspects, and as described above, one or more systems of the input recognition system may alternatively or additionally be provided on the server 805, the cloud or some other remote computing device. These systems are shown in the figure as input recognition system 835. The input recognition system 835 of this figure may refer to the input recognition system 120, the speech pronunciation generation system 140 or a combination thereof and may perform one or more of the operations described above with reference to FIG. 3, FIG. 4 or FIG. 5 and provide information or other data, over the network 830 to the various computing devices.

By way of example, the aspects described above may be embodied in a general computing device 810, a tablet computing device 815 and/or a mobile computing device 820. Any of these examples of the computing devices may obtain content from or provide data to the store 840.

As should be appreciated, FIG. 8 is described for purposes of illustrating the present methods and systems and is not intended to limit the disclosure to a particular sequence of steps or a particular combination of hardware or software components.

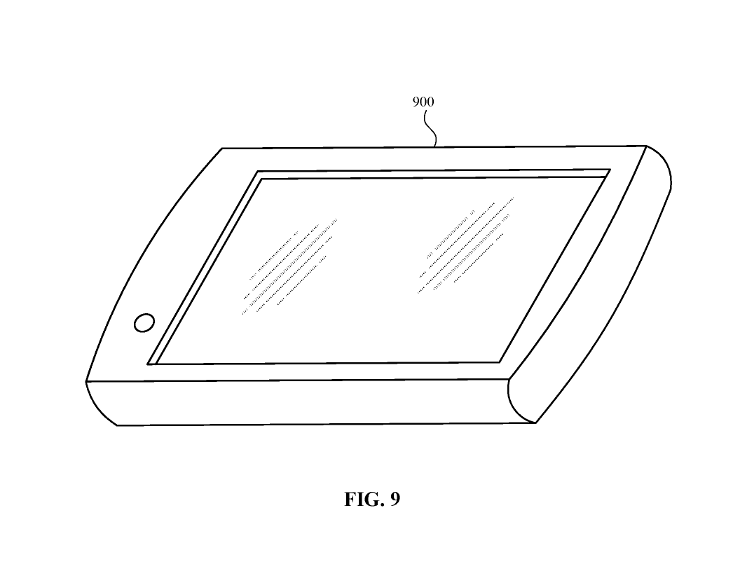

FIG. 9 illustrates an example tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more computing devices. For example, user interfaces and information of various types may be displayed and interacted with on a wall surface onto which user interfaces and information of various types are projected. Interaction with the multitude of computing systems with which examples of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, the figures herein FIG. 9 is described for purposes of illustrating the present methods and systems and is not intended to limit the disclosure to a particular sequence of steps or a particular combination of hardware or software components.

Aspects of the present disclosure describe a method, comprising: receiving a named entity input; performing a recognition operation on the named entity input; receiving contextual information associated with the named entity input; determining, based on the contextual information and on the recognition operation, a pronunciation of the named entity input; and outputting the pronunciation of the named entity input. The method may also include receiving additional input corresponding to the pronunciation of the named entity input. The method may also include automatically adjusting, without human intervention, a probability associated with the pronunciation of the named entity input based, at least in part, on the additional input. The method may also include generating a pronunciation database associated with a list of named entities, wherein the pronunciation database includes one or more variants of a pronunciation of one or more named entities in the list of named entities and wherein the named entity input is included in the pronunciation database. The method may also include using the contextual information to select a subset of the one or more variants of the pronunciation of the name of the individual. In some aspects, the one or more variants are associated with a probability that the pronunciation is substantially equivalent to the named entity input. In some aspects, the contextual information includes a geographical area from which the named entity input is provided. In some aspects, the contextual information includes recognizing a pronunciation of additional input associated with the named entity input. In some aspects, the contextual information includes information about a language used by a computing system that receives the named entity input.

Also described is a system, comprising: a processing unit; and a memory for storing instructions that, when executed by the processing unit, performs a method, comprising: receiving a request for a pronunciation of a named entity received as input; determining contextual information associated with the input, wherein the contextual information is used to select a subset of pronunciations of the input from a set of possible pronunciations of the input; selecting one pronunciation of the input from the subset of pronunciations of the input; and returning the one pronunciation of the input. In some aspects, selecting one pronunciation of the input from the subset of pronunciations of the input comprises using received feedback, in conjunction with the contextual information, to select the one pronunciation of the input. In some aspects, the system also includes instructions for updating a probability associated with the one pronunciation of the input. In some aspects, the contextual information is based, at least in part, on a determined origin of at least a portion of the input. In some aspects, the contextual information is based, at least in part, on a location from which the input originated. In some aspects, the input is spoken language input. In some aspects, the input is written text. In some aspects, the contextual information is based, at least in part, on a language utilized by a system that provided the request for the pronunciation of the named entity.

Also described is a method, comprising: receiving input corresponding to a named entity, wherein the input comprises at least one of contextual information corresponding to the named entity, a determined pronunciation of the named entity, and feedback associated with the name entity; selecting one pronunciation of the named entity from a set of pronunciation variants associated with the named entity; and automatically updating a score associated with the one pronunciation of the named entity. In some aspects, the feedback is negative feedback. In some aspects, the contextual information includes one or more of a determined location from which the named entity originated, a determined origin of at least a portion of the named entity; and one or more additional words included in the input.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
receiving, at a computing device, a spoken named entity input;
performing a speech recognition operation on the named entity input;
receiving contextual information associated with the named entity input;
determining, based at least in part, on the contextual information and on the recognition operation, a pronunciation of the named entity input;
outputting the pronunciation of the named entity input;
receiving, at the computing device, feedback regarding the pronunciation; and
automatically updating a probability associated with the pronunciation of the named entity input based, at least in part, on the feedback.

2. (canceled)

3. (canceled)

4. The method of claim 1, further comprising generating a pronunciation database associated with a list of named entities, wherein the pronunciation database includes one or more variants of a pronunciation of one or more named entities in the list of named entities and wherein the named entity input is included in the pronunciation database.

5. The method of claim 4, further comprising using the contextual information to select a subset of the one or more variants of the pronunciation of the name of the individual.

6. The method of claim 4, wherein the one or more variants are associated with a probability that the pronunciation is substantially equivalent to the named entity input.

7. The method of claim 1, wherein the contextual information includes a geographical area from which the named entity input is provided.

8. The method of claim 1, wherein the contextual information includes recognizing a pronunciation of additional input associated with the named entity input.

9. The method of claim 1, wherein the contextual information includes information about a language used by a computing system that receives the named entity input.

10. A system, comprising:
a processor; and
a memory for storing instructions that, when executed by the processor, perform a method, comprising:
receiving a request for a pronunciation of a named entity received as input at a computing device;
determining, based at least in part, on information associated with the computing device, contextual information associated with the input, wherein the contextual information is used to select a subset of pronunciations of the input from a stored set of possible pronunciations of the input;
selecting one pronunciation of the input from the subset of pronunciations of the input based at least in part, on received feedback, in conjunction with the contextual information; and
returning, to the computing device, the one pronunciation of the input.

11. (canceled)

12. The system of claim 10, further comprising instructions for updating a probability associated with the one pronunciation of the input.

13. The system of claim 10, wherein the contextual information is based, at least in part, on a determined origin of at least a portion of the input.

14. The system of claim 10, wherein the contextual information is based, at least in part, on a location from which the input originated.

15. The system of claim 10, wherein the input is spoken language input.

16. The system of claim 10, wherein the input is written text.

17. The system of claim 10, wherein the contextual information is based, at least in part, on a language utilized by a system that provided the request for the pronunciation of the named entity.

18. A method, comprising:
receiving, at a computing device, input corresponding to a named entity, wherein the input comprises contextual information associated with the computing device and corresponding to the named entity, a determined pronunciation of the named entity, and feedback associated with the name entity;
selecting one pronunciation of the named entity from a set of pronunciation variants associated with the named entity based at least in part on the contextual information, the determined pronunciation and the feedback; and
automatically updating a score associated with the one pronunciation of the named entity.

19. The method of claim 18, wherein the feedback is negative feedback.

20. The method of claim 18, wherein the contextual information includes one or more of a determined location from which the named entity originated, a determined origin of at least a portion of the named entity, and one or more additional words included in the input.

21. The method of claim 18, wherein automatically updating a score associated with the one pronunciation of the named entity comprises automatically updating a probability associated with the one pronunciation.

22. The method of claim 1, wherein the feedback is negative feedback.

23. The system of claim 10, wherein the one pronunciation of the input in provided as audible output.
